(19) United States
(12) Patent Application Publication
(10) Pub. No.: US 2024/0061946 A1
(43) Pub. Date: Feb. 22, 2024

(54) PRODUCT DATA EXCHANGE SYSTEM AND NETWORK

(71) Applicant: Anarus, Inc., Savage, MN (US)

(72) Inventor: Prashubh Batham, Savage, MN (US)

(21) Appl. No.: 18/452,306

(22) Filed: Aug. 18, 2023

Related U.S. Application Data
(60) Provisional application No. 63/399,128, filed on Aug. 18, 2022.

(51) Int. Cl. G06F 21/62; G06Q 10/08

(52) U.S. Cl. CPC G06F 21/6218; G06Q 10/08; G06F 2221/2141; G06F 2221/2113

(57) ABSTRACT

A system for the controlled sharing of information related to products provided by a manufacturer with selected supply chain members. The system maintains manufacturer records and supply chain member records in a user database, manufacturer company records in a company database and product records in a product database. Each manufacturer and each supply chain member are assigned unique global network identification numbers (GNIN) within the system. Further, each product is provided with a unique product ID and assigned to at least one group or subgroup. Product information from a manufacturer is controlled by requiring an appropriate entry in both the manufacturer user record and the supply chain member user record before information related to that product can be provided to the supply chain member. Product information can be designated by the product ID or by appropriate group and/or subgroup entries. All records are stored in a JSON format within big data containers so that no size limitations exists.

### BACKGROUND

Managing product information can be challenging and complicated for manufacturers and product suppliers. Accordingly, there is a desire to have a comprehensive system to provide useful information to distributors, dealers, suppliers, and/or customers, so that buying decisions are easily accommodated. However, in many circumstances a manufacturer or product provider may have limitations on what information can be publicly shared. As one example, a manufacturer or product supplier may have confidential pricing arrangements with certain customers. In other circumstances, only limited product offerings, options or features may be provided by a manufacturer to a particular user/buyer/distributor for multiple reasons.

The online sales of products has become wide stream and expected by various buyers, including consumers and industrial buyers. In addition, substantial amounts of information, from specifications to product descriptions to user reviews are expected in virtually all circumstances. Obviously, online marketplaces accommodate the sharing of this type of information, but as suggested above, there are also needs to control its dissemination. In certain circumstances, these issues are greatly exaggerated. For example, in the industrial supply markets, the need for very detailed information related to thousands of products exists widely. However, many manufacturers may have multiple product lines, multiple product categories, and other offerings that may not be widely presented to each customer or distributer. As such, manufacturers and product suppliers have a need to provide information on a controlled and managed platform, which allows only certain users to see certain pieces of information, or certain categories of data. Distributors, dealers, and/or sales representatives may have a similar need to control the information that buyers have access to.

### SUMMARY

A SaaS product data exchange network for B2B manufacturers, distributors, dealers and contractors is further described below which provides the ability to efficiently share Rich Product Data for a variety of applications including ecommerce, ERP, CRM and mobile apps. Further, the specific information shared with others can be controlled and limited, thus providing individuals with the ability to manage information in a manner that fits their commercial needs.

In most circumstances, when buying products online the process begins by first reading about the product(s) and gathering information. Product information is often just as important as the product itself. The network or system is described herein as a product data exchange system that allows users to easily access product information, which is relevant and applicable to them. The product data exchange system (also referred to as the “Anarus System” or “Anarus Platform”) enables a cloud-based product information exchange from manufacturers to distributors, retailers, and contractors, so everyone can buy confidently online. Using the system, companies can save several thousands of dollars annually through efficiency and accuracy of information. This market opportunity is significant and is valuable to the complete supply chain from manufacturer to distributor to contractor and ultimately, to end user.

In the discussion below, various users of the product data exchange system are referenced and discussed. In the example embodiments, it is generally contemplated that a “manufacturer” will be an organization that develops, manufactures, and/or sells goods to others. This description is intended to be broad and non-limiting, including contract manufacturers, or importers, which generally provide a source for a particular product. It is also contemplated that several supply chain members will be participating in the product data exchange system. Generally, these supply chain members may include distributors, dealers, sales representatives, authorized online resellers, or other related parties that are involved in the commercial flow of products. Again, this is a non-exhaustive list of potential users, and other alternatives may exist. Lastly, end users or purchasers are also contemplated as part of the product data exchange system. It is initially contemplated that the product data exchange system is most applicable and beneficial for business-to-business transactions; however, the technology and concepts described herein could also be applicable to consumers.

Manufacturers build millions of new products each year. Each unique product is typically given a unique ID (e.g. a part number and/or UPC code). Each unique product contains one or many unique attributes, which is why a unique ID is provided/assigned. The product data exchange system maintains product data for a large number of items supplied by a large number of manufacturers in a unique hierarchy so it can be securely and selectively provided to and/or accessed by an unlimited number of distributor/dealers and other affiliates.

Using the product data exchange system further described herein, access to product data can be controlled by manufacturers on many levels, including a general level or a granular level. This allows for the controlled access of product data for certain products or product types to certain supply chain members in certain regions and/or business categories.

Each user of the product data exchange system will be registered and assigned a global network identification number (GNIN). The GNIN (also referred to as a Global ID) is used internally by the system to connect supply chain members (e.g., distributors, dealers, sales representatives, contractors, . . . ) to certain data records maintained by the manufacturer. As will be discussed in further detail below, the GNIN is also used to connect one manufacturer to many different supply chain members and vice versa.

The product data exchange system uses “data containers” to store various records, which are data structures set up to hold data in JSON format. In the system, each manufacturer is assigned one or many containers. The size of the container is unlimited, which will provide several advantages as outlined below. One type of record is a product record which is a JSON record containing an unlimited number of product attributes for each unique product type. There can also be an unlimited number of product types in a data container. Examples of anticipated attributes for a particular product may include product categories, sub-categories, specifications, and any related external file names or identifiers (linked to documents, images, Videos etc.), and/or links. Additionally, the system separately contains a database table having an industry standard product attribute dictionary for all possible attributes corresponding to each unique product ID.

In summary, the product data exchange system provides a two-way private network between a manufacturer and their related supply chain members to share access to specific data records specific to each supply chain member's needs. It also provides a direct way for a manufacturer to receive input specific to each product. Additionally, using the product data exchange system, manufacturers can broadcast product specific bulletins (recalls, updates, corrections, warnings, etc.) to their private network of supply chain members.

To provide further flexibility, the product data exchange system architecture is built using multiple microservices in the Cloud, which will provide optimum performance given the large number of records within multiple containers, and the multiple tables used by the system. Some of these microservices are accessed simultaneously as multiple users try to use the system thus requiring processing power and data bandwidth which is best provided in a cloud computing environment.

### BRIEF DESCRIPTION OF THE DRAWINGS

Further advantages of the product data exchange system, and related product data exchange network can be seen by reading the following detailed prescription, in conjunction with the drawings in which;

FIG. 1 is a schematic illustration showing the product data exchange network;

FIG. 2 is a data outline illustrating the conceptual data structure utilized by the product data exchange network;

FIG. 3 is a data flow chart;

FIG. 4 is a simplified version of example data structures used in the product data exchange network;

FIGS. 5A-5C outline a more detailed data structure, illustrating various concepts of a user database and a company database;

FIGS. 6A-6B provides a data illustration showing an exemplary product record contained in the cloud container of a product database;

FIG. 7 is a user interface illustrating the initial process used by a manufacturer making a connection with a supply chain member;

FIG. 8 is a similar user interface illustrating the process of a manufacturer selecting a database to share with a supply chain member;

FIG. 9 is a user interface illustrating tools for showing what supply chain members are connected with the manufacturer;

FIG. 10 is aa user interface illustrating the process of a distributor accessing a manufacturer's data;

FIG. 11 is a user interface showing a tool for a supply chain member to request a connection with a manufacturer;

FIG. 12 shows a user interface which allows supply chain members to post a review or comment related to a product;

FIG. 13 is a user interface illustrating a manufacturer's ability to send a bulletin or similar information to its supply chain members; and

FIG. 14 is a further user interface illustrating a product search mechanism.

### DESCRIPTION

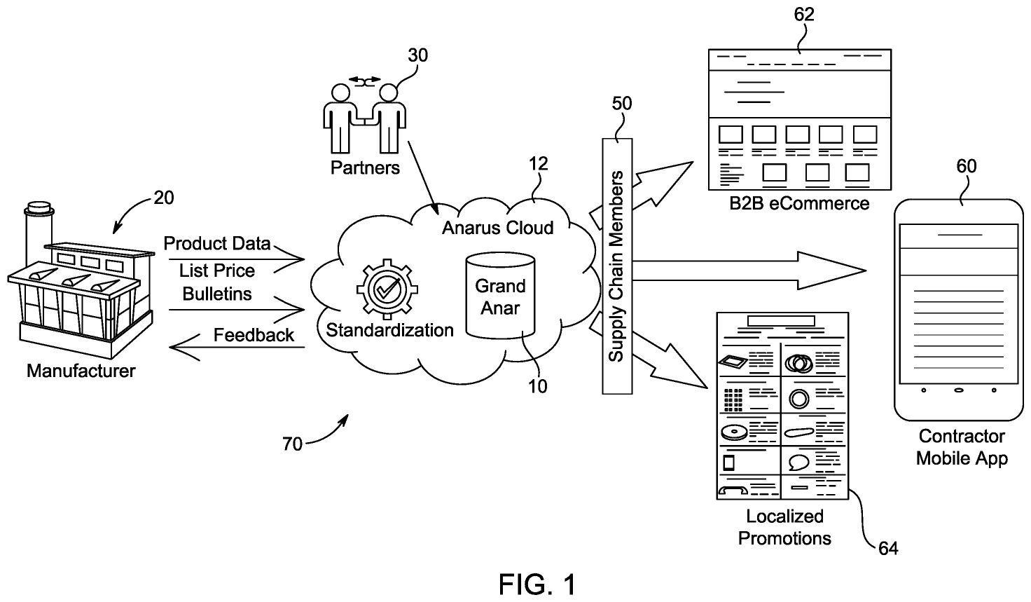

The product data exchange system 10 is uniquely configured to allow for the coordinated exchange of product information between manufacturers and other supply chain members. As illustrated in FIG. 1, the product data exchange system 10 is generally illustrated as a cloud application, operating a cloud environment 12. It will be recognized that the processing of information in cloud environment 12 is particularly effective due to the amount of data used in the product data exchange system 10, however it is also possible that a local computing approach could also be used, and this description is not intended to be limiting in any way. Further, the processing or logic used by the product data exchange system 10 could be implemented using several types of data formats, programing languages, etc. following the principles described herein.

In this general illustration, a manufacturer 20 will be a primary user of the product data exchange system 10, allowing product data, price lists, bulletins, and other information to be shared in a controlled and selected manner, while feedback can also be provided to manufacturer 20 by various supply chain members 50. Supply chain members 50 have the ability to interact with product data exchange system 10 utilizing several interfaces, including a contractor mobile app 60, a B2B ecommerce interface 62, or various customized communication methods 64 that could be sent out as promotions, special promotions or other types of data exchange mechanisms. Naturally, other user interfaces could be possible, such as embedded websites or customize APIs interacting with a supply chain member's system. It should also be noted that other partners 30, may be able to interact with the product data exchange system 10, such as suppliers who coordinate with manufacturer 20 or service providers of various types. In summary, the elements generally illustrated in FIG. 1 show how a product data exchange network 70 is generally configured, with various participants involved in the network 70 to achieve certain goals.

As mentioned above, various supply chain members 50 will interact with a product data exchange network 70 in various ways. Again, it is contemplated that supply chain members may include several types of organizations or persons, including sales representatives, distributors, manufacturer representatives, dealers, or other organizations that will coordinate the sale and distribution of a manufacturer's products. While the present description will utilize an example of product manufacturers, and related product sales, it is appreciated that a similar system could be created for service providers of different types. Further, the sale of software and/or other types of products could benefit from the features and advantages of product data exchange network 70.

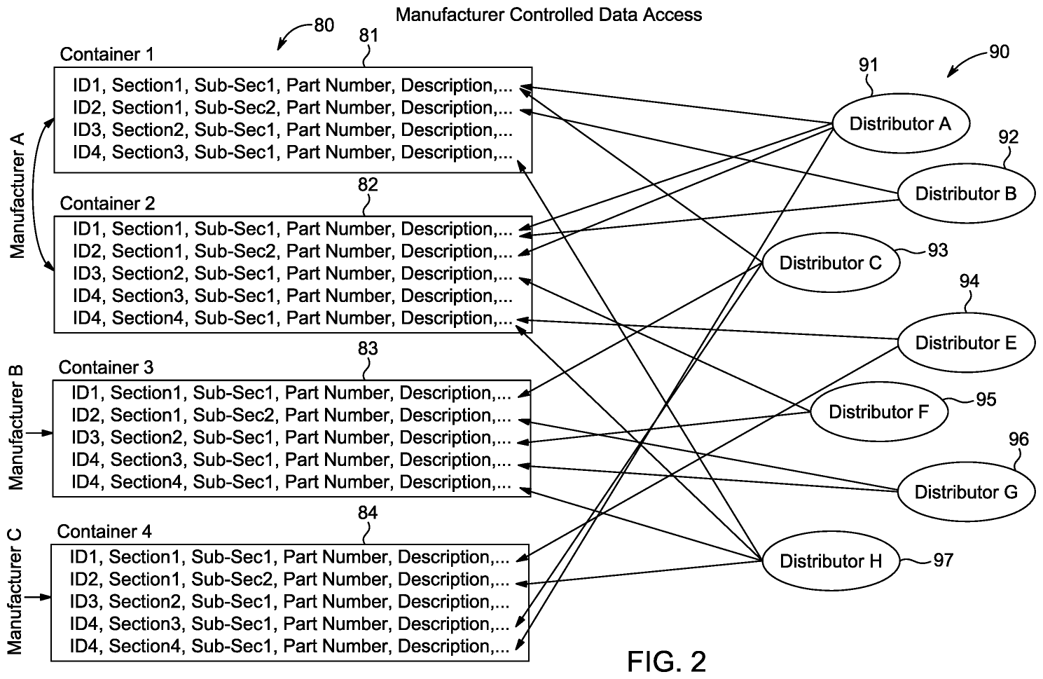

Turning now to FIG. 2, one portion of an exemplary data storage and data access strategy for product exchange system 10 is generally illustrated. As shown in FIG. 2, a number of containers for storing data, 81, 82, 83 and 84, are conceptually illustrated. In this example, data related to products from a first manufacturer (manufacturer A) is contained in a first container 81 and a second container 82. Further, manufacturer B will have its data stored in a third container 83 while manufacturer C will have its data stored in fourth container 84. It is generally contemplated that each container will be assigned to a single manufacturer, within each container are a number of records related to products offered/sold by that manufacturer. In this example, each record will include an ID number, a section identifier, a subsection identifier, a part number and description information. Also illustrated in FIG. 2 are a plurality of supply chain members 90 (in this illustration, each supply chain member is listed as a “distributor”). More specifically, FIG. 2 shows distributor A 91, distributor B 92 . . . through distributor H 97. As also conceptually illustrated, each distributor will have access to limited portions or records within each container. As will be further described below, the data structure utilized and the related logic provides mechanisms for this controlled access to information, in a manner that allows the manufacturer to selectively provide access.

Again, product data exchange system 10 makes use of several records, with all records stored in JSON format using BIG Data containers in a set of Cloud Databases. Generally, there are three main databases used by product data exchange system 10, including a User Database, a Company Database and a Product Database. While the present description makes use of the term “Database” to characterize collections of information, it will be understood that these data structures do not follow the typical “Database” structure that is often recognized by those skilled in the art. For example, several versions of SQL databases exist that are well recognized as ordered tables and structured data arrangements, which are efficient and effective for several purposes. As will be further discussed below, the “Databases” described in the embodiments and various aspects of the product data exchange system largely exist in the form of various records organized in a JSON format. That said, they operate as databases, due to the fact that they collect and store ordered collections of information, which can be effectively used by the product data exchange system.

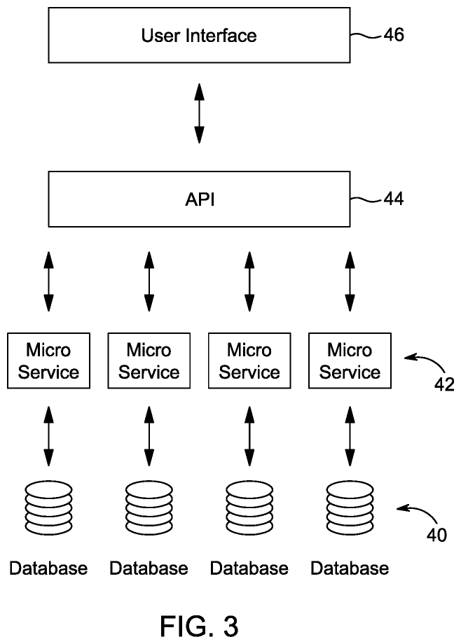

Turing now to FIG. 3, a general data flow is illustrated related to the transmission of information between parties. In FIG. 3 a plurality of databases 40 are illustrated, each accessible by a related microservice 42. This access allows certain portion of the data to be accessed and retrieved, as specified in the related communication. In this illustration, an API 44 exists, in communication with a user interface 46 to allow access to data. As will be discussed below, the user interface could theoretically be a supply chain member system, attempting to pull information related to certain products, or a manufacturer system providing specified instructions. It should also be noted that an API may not always be included, as a specialized user interface may be configured and need to access microservices alone, thus limiting the need for the API 44.

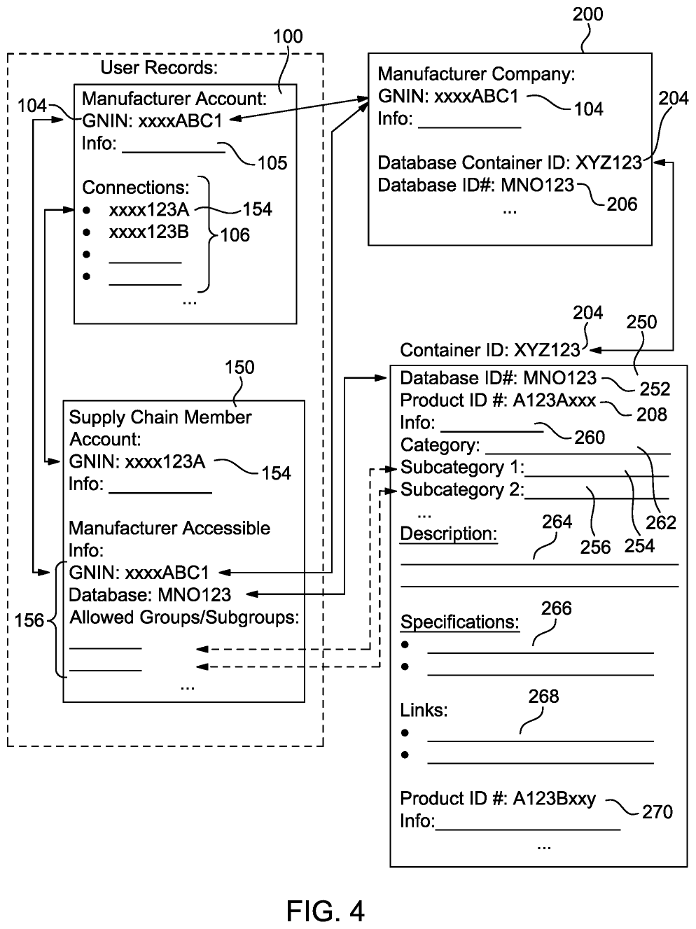

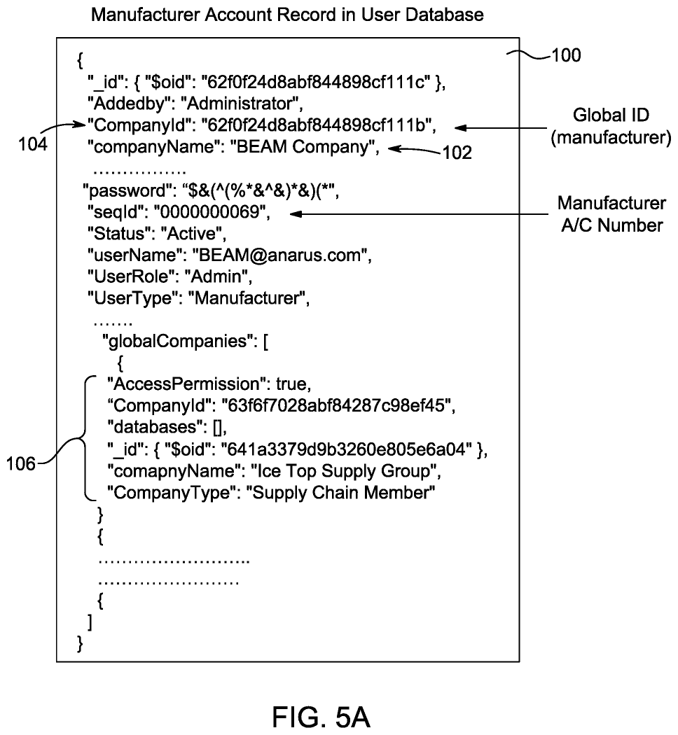

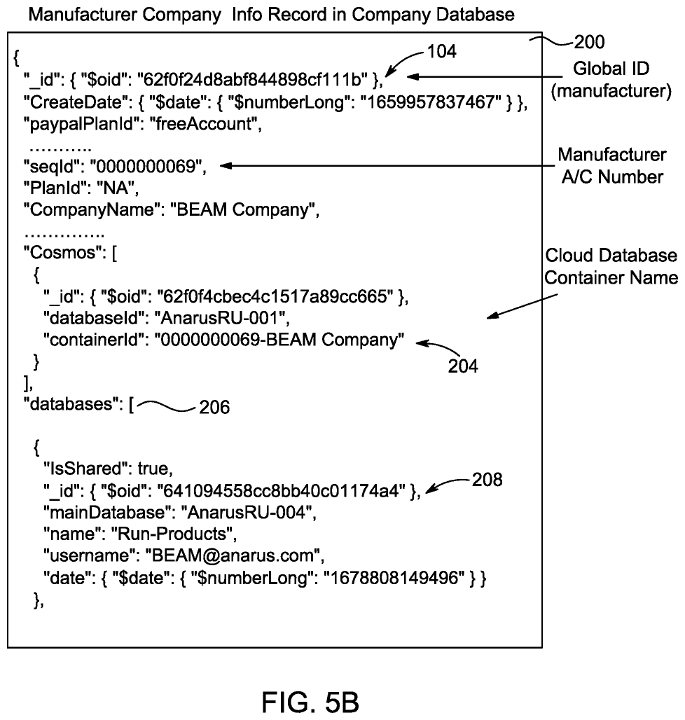

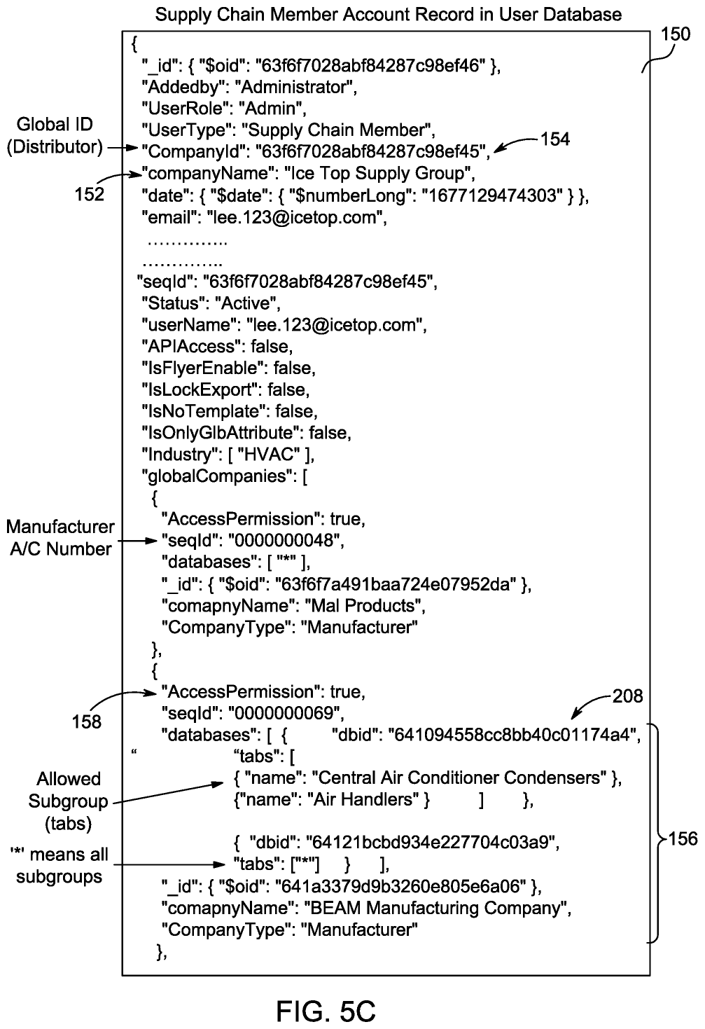

In a first aspect of the product data exchange system, all users of the product data exchange system, including but not limited to manufacturers and supply chain members will be provided with a user record, typically created when an account is created, which will be stored in a User Database. A first exemplary user record 100 and a second exemplary user record 150 are illustrated in FIGS. 4, 5A and 5C. In this illustration, first user record 100 is a manufacturer user record (shown in FIG. 5A as a record for Beam Company as recorded in “Company Name” field 104). In a similar manner, a supply chain member user record 150 is also shown (with FIG. 5C specifically illustrating a record for Ice Top Supply Group as recorded in “Company Name” field” 152).

Turning now to FIG. 4, which presents a simplified illustration of manufacturer user record 100 and supply chain member user record 150. Manufacturer record 100 includes a listing of manufacturer ID 104, certain general information 105, and a listing of approved connections 106. In a similar manner, supply chain member record 150 includes a user ID 154, along with a listing of allowed information 156 (including manufacturer ID, allowed groups and allowed subgroups.) In this illustration, groups/subgroups and category/subcategory labels are used interchangeably and intended to have the same meaning. While FIG. 4 only lists a limited amount of allowed information 156, it will be understood that the supply chain member's user record 150 could list one or many different connected manufacturers in allowed information section 156, with each manufacturer providing access to multiple products. In this example, supply chain member's user ID 154 is also listed in manufacturer user record 100 (in connections section 106) thus establishing that this particular supply chain member has access to product data controlled by the listed manufacturer.

As mentioned above manufactures and supply chain members both are assigned a unique GNIN which is stored in ID fields 104 and 154 (i.e. listing the GNIN for the particular user), respectively, which is used to correlate additional information. As will be discussed below, system large will look for appropriate GNIN listings before allowing certain actions.

Referring again to FIG. 4, database record 250 contained in container ID 204 (which is listed in manufacturer record 200) will contain information for products assigned to a particular manufacturer. A product record within this container will be identified by a product ID 208 and will include several pieces of information related thereto. Specifically, this information may include a product info field 260, a product category field 262, subcategory fields 256 and 257, product description field 264, specifications field 266 and data links 268. This information is all related to the particular product ID number 208. In this example, product database 250 will also contain a second product ID 270, along with similar information related to another product offered by the relevant manufacturer. As would be recognized, the number of products listed herein can be endless, thus allowing a mass amount of information to be stored and correlated utilizing the product data exchange system 100 discussed herein.

Again, it will be noted that FIG. 4 identifies various correlations between user records 100, company records 200, supply chain member user record 150 and product database 250. By specifically configuring these databases to provide correlation, the system logic can thus control access and the dissemination of information in a controlled and efficient manner, as generally discussed above.

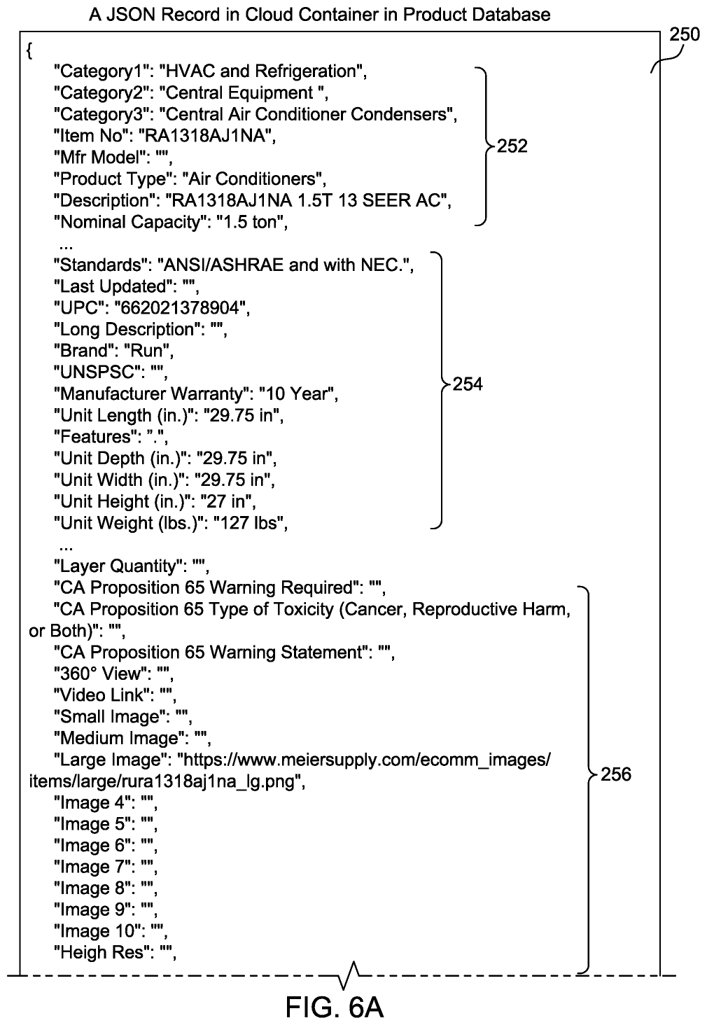

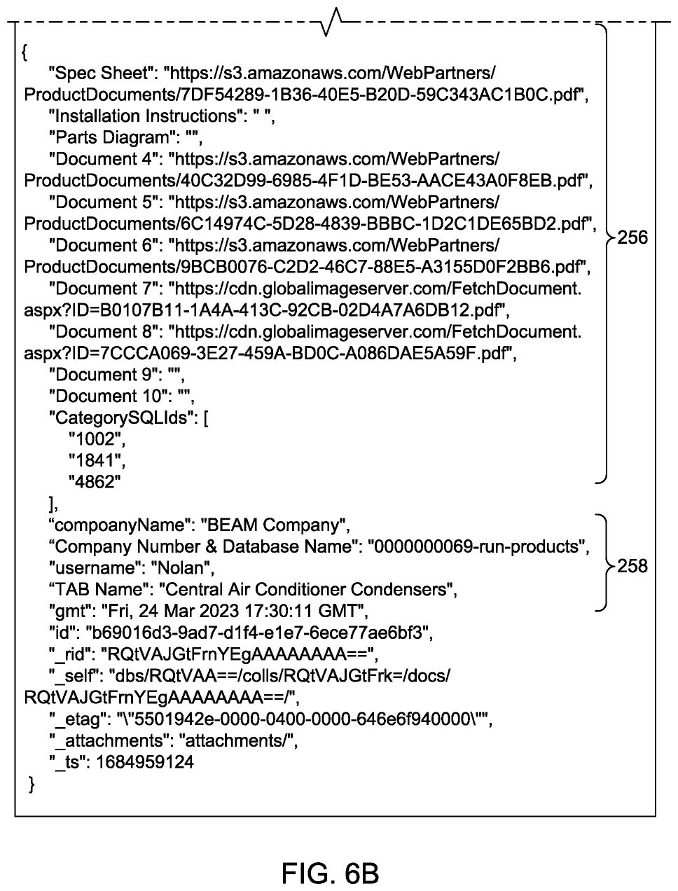

When a manufacturer creates a database for the listing of product information, a record is also written into a Company Database Record 200, which again contains manufacturer's GNIN 104 and information related to that manufacturer's data. As one example, company database record 200 will identify which product database (record) belong to a particular manufacturer. More specifically, company database record 200 will include a container ID section 204, which provides a mechanism to identify the container holding that manufacturer's product data, and all relevant product database ID numbers 206. These provide mechanisms to identify which product database holds product information for the listed manufacturer. An exemplary product database record 250 is illustrated in FIGS. 4 and 6A-6B.

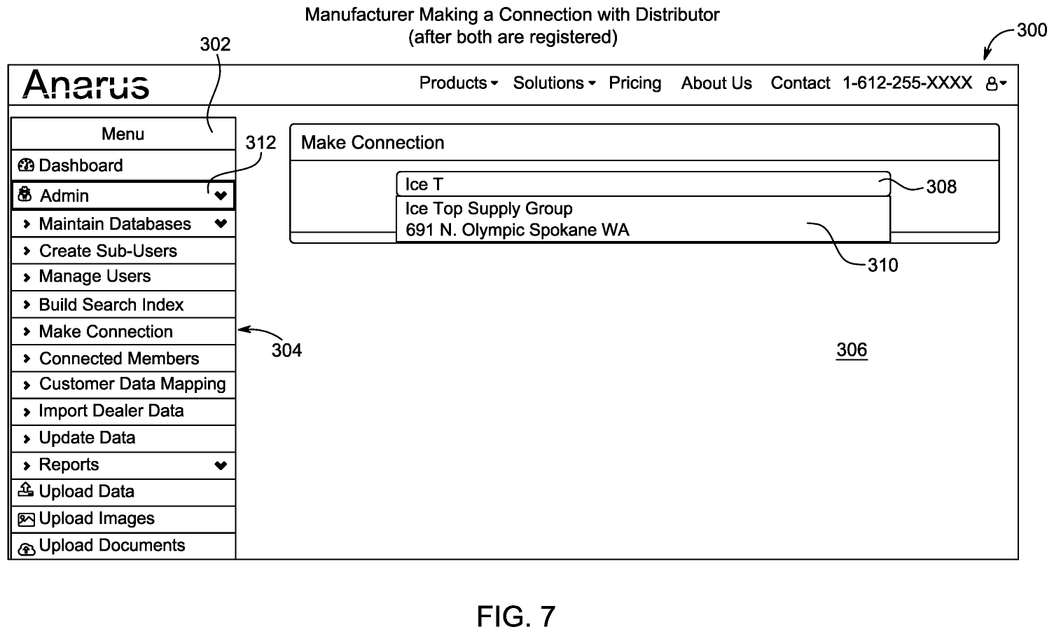

Using the data structures and logic discussed above a manufacturer has the ability to “connect” with multiple supply chain members, to thus provide a mechanism to share production information. An example of the user interface used to achieve this (i.e., a manufacturer connecting to a supply chain member) is shown in FIG. 7. In the appropriate records, this, the system will modify a manufacturer's record 100 in User Database to add appropriate supply chain members GNIN 154 and other identifying fields such as supply chain member's name, to an access listing 106, as generally shown in FIGS. 4, 5A and 5C. It will be understood that system logic will require certain records in appropriate places before access to information is provided. For example, supply chain member user record 150 must include the listing of the manufacturer GNIN before access to information for that manufacturer is provided. Similarly, manufacturer user record 100 must also list a supply chain member GNIN (as a connection) before such access is provided.

The user interface 300 illustrated in FIG. 7 shows one exemplary layout that allows a manufacturer to make a connection with a supply chain member thus cause appropriate data structures to be created. In this illustration, it is assumed that the manufacturer has signed into the system and is provided an administrative page based upon an appropriate selection from the menu 302 shown on the left side of user interface 300. In this example, the manufacturer has chosen “make connection” 304 from the menu 302, thus bringing up a supply chain member selection tool 306. As illustrated, supply chain member selection 306 includes a search box 308, in which a manufacturer is allowed to start typing the proposed name of the possible connection. In this example, the manufacturer is searching for an organization called Ice Top Supply, and thus has started typing “Ice T” in the search box 308. The user interface 300 thus provides quick results allowing a drop-down menu 310 to appear with the details related to organization named Glacier Supply. At this point, the manufacturer is allowed to select this organization, and the system will thus make an appropriate adjustment in the manufacturer's users database record 100 to indicate that Ice Top Supply is a valid connection and thereby allowing access to the manufacturer's information by this new connection (i.e., Ice Top Supply). It should be noted that user interface 300 has several other selections possible in menu 302, which are generally self-explanatory.

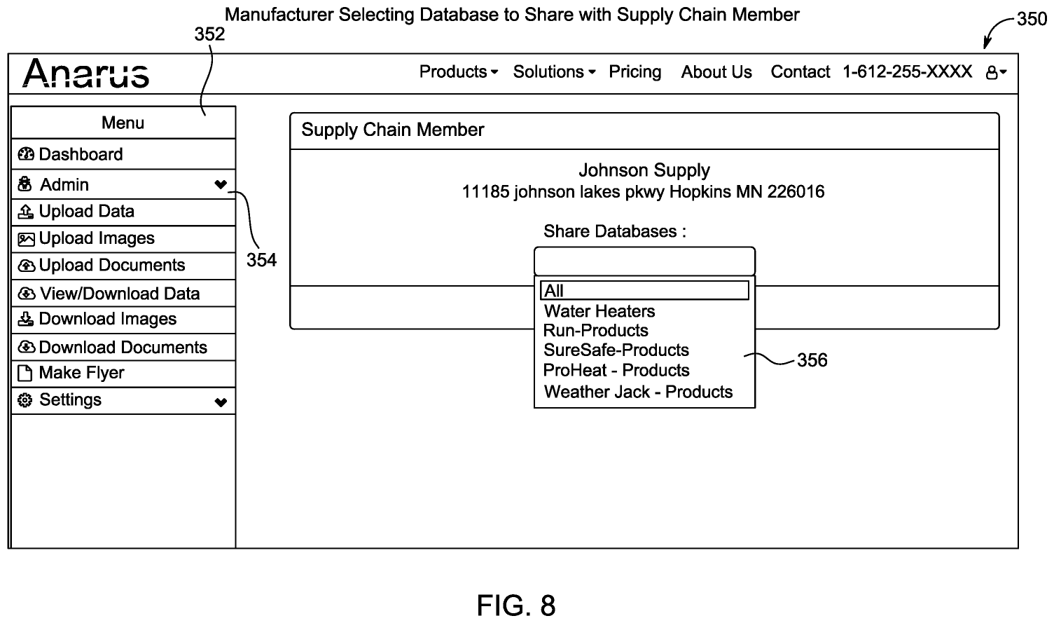

Turning now to a typical step carried out by a manufacturer, where they will select one or many databases that they want to share with the newly connected supply chain member. A product selection interface 350 for carrying out this process is generally presented in FIG. 8. As mentioned above, each database can have one or many sub-groups (TABS). After the manufacturer has identified the supply chain member (i.e. Johnson Supply in FIG. 8), a drop-down menu 356 is presented to the user (i.e. a manufacturer), allowing for the selection of appropriate groups or subgroups. Here, the manufacturer can identify “All” groups/subgroups or certain subgroups. In this illustration, a user has selected “admin” 354 in menu 352, thus allowing for the selection of particular supply chain members. In response to a desired selection in drop-down menu 356, supply chain member's record 150 in User Database is modified to add manufacture's account number, access permission, database ID and TAB names in a manufacturer access section 156 (see, FIG. 5C). For all databases or all TABS an “*” is written in database array or TABS array to thus allow access to all databases provided by the manufacturer.

Again, FIGS. 6A-6B show a sample record from Product Database Container. One record for each product from a particular manufacture is written into a predetermined container in the product database. As mentioned above, these records are in JSON format thus allowing variable number of fields within each record. At the end of each records a number of fixed fields 258 include information used by the system 10 to identify the database and provide a TAB (i.e. a subgroup) for a product record which is correlated with in a particular Manufacture's container. As shown in FIGS. 6A-6B, product record 250 in a product database includes a large amount of information, in addition to the above-mentioned fixed fields 258. As an example, a category section 252 will identify the product type, and any categories that this particular product will fall into. In addition, a large number of specifications are provided in specification section 254, such as physical dimensions, standards, brand, etc. Also presented are entries in an additional information section 256, which may include links to images, spec sheets, document references, and additional information to be presented related to this particular product. As one example, the additional information section identifies when a California proposition 65 warning is required. All of this information is usable by the system to present information to various supply chain members about a particular product, when needed.

When a manufacturer loads their product information into the product data exchange system, standard attribute dictionary table directs them to select the most appropriate category and subcategory for a product or group of products. Once categories are selected, the product data exchange system 10 prompts them for all possible attributes of the selected type of product(s). The manufacturer is then provided with tools (e.g., drop-down menus, data input fields, etc.) to map its product attributes to the listed product attribute options for the particular product type. By using this mapping, all products for a set of categories can be loaded at one time. This process is repeated for each unique category or product. Once product data is loaded in a container, it is standardized to the correct industry standard before allowing access by other supply chain members. Mapping for all products of a particular manufacturer is then saved in the system defined container within the for any future updates and/or deletion of products.

To provide additional functionality, a manufacturer can load their data in many different sections within a container and give it a unique name within that container. For example, all power tools can be loaded in one section and called “Power Tools” while all hand tools can be loaded in a section called “Hand Tools.” Data can be loaded either in batch process manually or via APIs using similar data mapping strategies. In the product data exchange system 10, manufacturers load their data in one of many containers which can contain one or many sections, and which can contain one or many sub-sections.

Again, there can be an unlimited number of sections in a container, with each section being further divided into sub-sections (TABS). In addition to the container structure mentioned above and generally shown in FIG. 2, each JSON record contains a Section Name, a Sub-Section Name, a Manufacturer ID and several other identification fields to identify source for that particular JSON record.

Once data is loaded, the product data exchange system 10 provides the manufacturer an option to search supply chain members within a registered user's table kept in a separate database (with the users identified by their GNIN). Once a registered user is identified as a relevant member of a supply chain, manufacturers can give them access to one or many different data sections contained within a container. They can also choose a sub-section within a section to which a particular customer will be provided with access. It is generally contemplated that a supply chain member will only have access to the allowed section or sub-section of a database, with access controlled by the relevant manufacturer. This access is typically provided by the manufacturer during a set up process, but a registered supply chain member in the product data exchange system can also request access (from any registered manufacturer) as discussed below. It is also possible for a manufacturer to provide read-only access to a supply chain member, to provide access to one or many manufacturer's products, or to provide only limited information. Additionally, manufacturers can revoke permission to access their data for any supply chain member at any time.

Further, manufacturers can have one or many users supply chain members data within the product data exchange system—with many possible levels of access to data elements. (e.g., read only, read-write, administration, generate PDF export.) This provides an additional level of data control, and methods of data presentation for users.

When accessing manufacturer's data using the custom user interfaces provided by the product data exchange system, supply chain members can select individual part numbers (product IDs), a section, or one or many sub-sections within a container then download information in many different formats. (i.e., Excel, JSON, .txt.). It is also possible to generate custom data export templates for exporting data in different field layouts. Supply chain members can also connect their internal systems (PIM, ecommerce etc.) using specific APIs with same terminology.

In addition to providing mechanisms to support product data as discussed above, each time supply chain member accesses a manufacturer database or downloads a section or a subsection of data, a log entry is created. This log can be accessed by the manufacturer to learn who is accessing their data and which particular part IDs are being accessed by any given user. Supply chain members are also provided with the ability to write a review or rate a particular product ID within the product data exchange system. Submitted reviews and ratings can then be accessed by the appropriate manufacturer for a proper response to the distributor/dealer. This functionality can also be accessed by others within a manufacturer organization. As is well recognized, submitted review information can be helpful in improving products and make necessary changes or updates. It is further contemplated that written reviews are visible only to supply chain members with approved access to the product IDs or sections/sub-sections belonging to that ID, however this access can be further customized by a manufacturer.

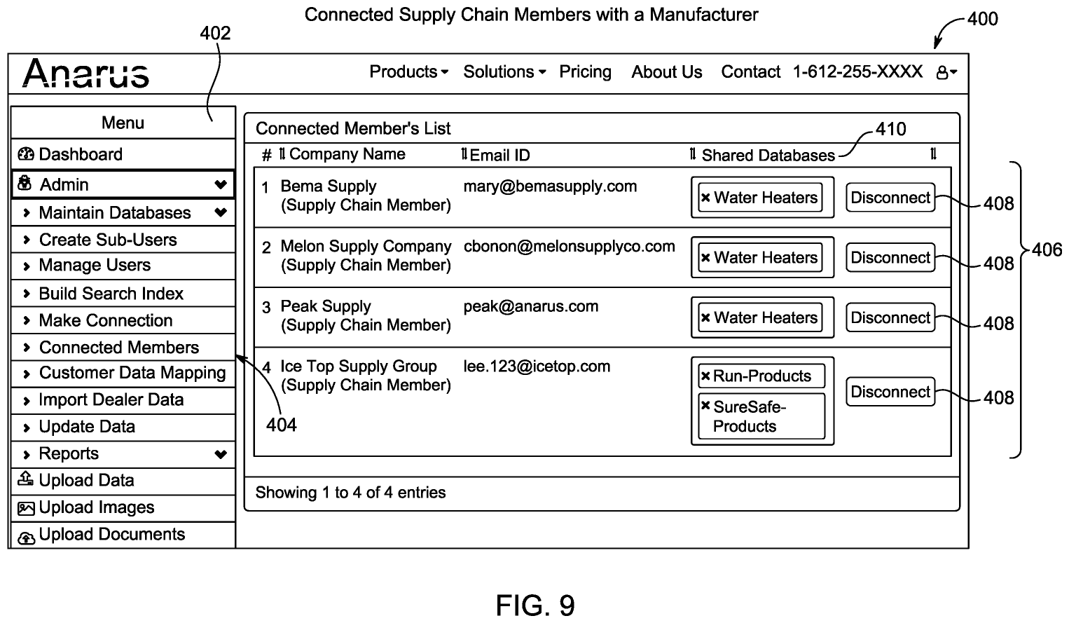

As shown in FIG. 9, the product data exchange system 10 provides the ability for manufacturers to see their connected supply chain members, based upon their own records in manufacturer User Database. As illustrated, a user interface 400 is provide where a manufacturer connected supply chain members can be seen and additional tools are provided. Using the menu 402, and selecting “connected members” 404, a list is produced showing the connected supply chain member in a list section 406. Using an appropriate disconnect button 408, the manufacturer can “disconnect” any supply chain member at any time. In this case, selection tool 405 is provided in interface 400, which might be a pull down menu related to the “disconnect” button 408. If a supply chain member's permission to access a manufacture's database is revoked, “AccessPermission” 158 is changed to “false” in supply chain member's record in the User Database (see FIG. 5C) and supply chain member immediately ceases to have access that manufacture's database(s). A manufacturer can also allow a database but revoke permission for a subgroup to be accessed by a supply chain member by going through the shared databases listing 410. Once a subgroup has been revoked, the supply chain member record in User Database is modified to remove that subgroup.

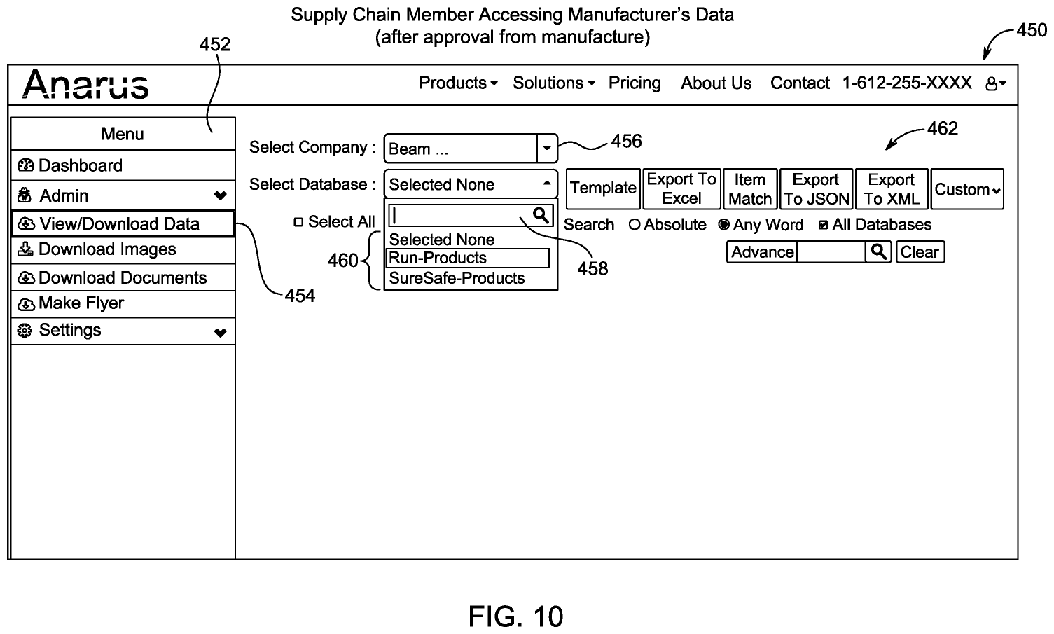

As shown in FIG. 10, within user interface 450 supply chain member is presented with a list of manufactures it has access to based upon supply chain member's record (FIG. 8) in User Database. Once supply chain member selects a manufacture in selection box 456, they are displayed allowed (AccessPermission: True) databases from that manufacture based upon the supply chain member's record. When a database from this manufacture is selected in selection box 456, subgroups (TABS) and SKUs within these subgroups are displayed after querying manufacturer's container and selecting records with database and TAB names. These records can then be downloaded to Supply chain members computer or accessed by their other software programs via APIs. As shown this can be downloaded in many different formats using selections 462.

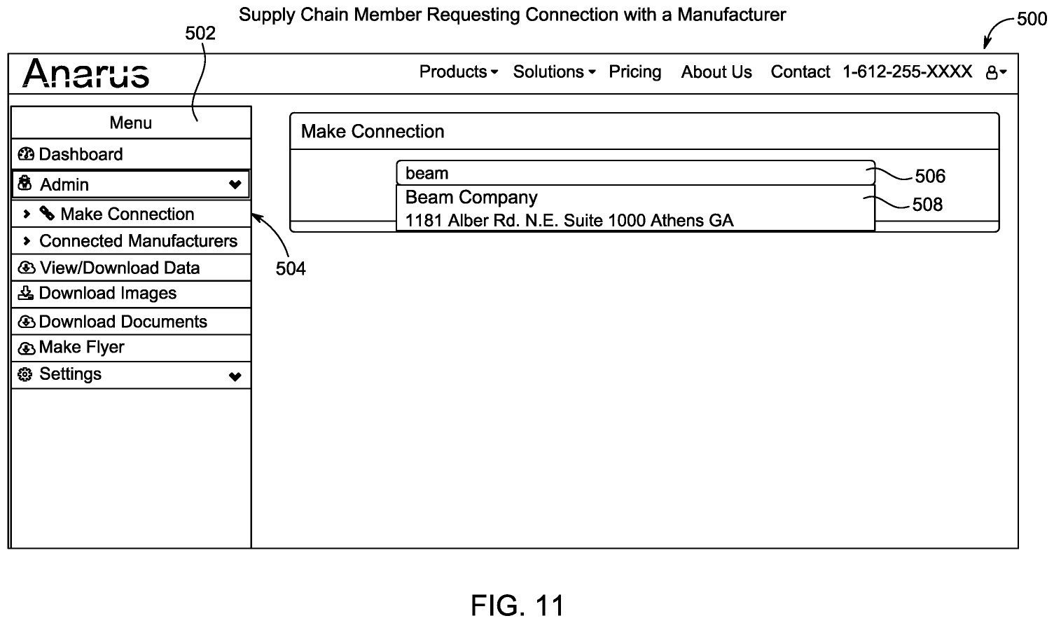

As shown in the user interface of FIG. 11, a supply chain member can search for a manufacturer from their user interface and request a connection. Generally, this interface allows for the searching of manufacture records by manufacturer names and eventually an email is sent to manufacture for approval. As illustrated, once a supply chain member is logged in, user interface 500 allows selection “make connection” 504 in menu 502. Once selected, a search tool is presented, which provides a search box 506. In this example, the supply chain member has begun by typing “beam” in search box 506, which results in the presentation of a selection box 508 being presented, which in this example is for the beam manufacturing company. The supply chain member is than allowed to select this manufacturer, thus initiating the process for a connection to be made. Behind the user interface 500, the system will thus generate an email to the beam manufacturing company, indicating that this particular supply chain member has requested a connection. At that point, using tools available to the manufacturer, appropriate steps can be taken to establish a connection.

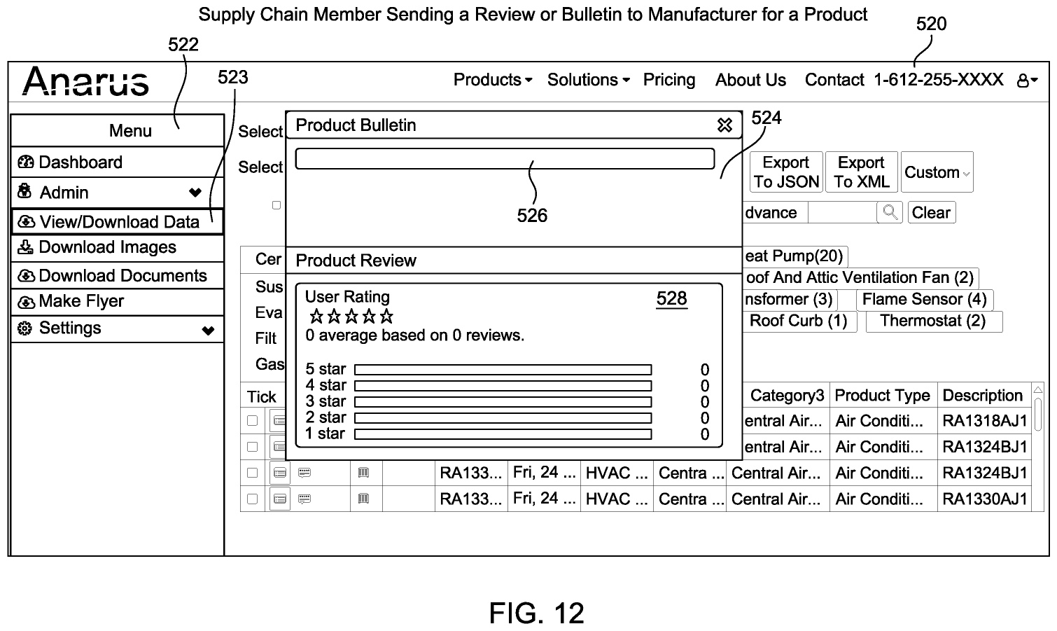

A supply chain member can also inform a connected manufacturer about an issue or review of a product using review tool 520, illustrated in FIG. 12, by selecting view/download data 523, in menu 522, product information is presented to a supply chain member. In this selection, a product bulletin screen 524 can be selected where a bulletin or product review can be produced by the supply chain member and routed back to a particular manufacturer. As will be appreciated, a text box 526 can be presented the supply chain member, allowing a freeform entry of comments or “bulletin” information. Further, a product review mechanism 528 is also presented to the supply chain member, which allows them to select reviews using a typical one-to-five-star type rating. As mentioned above, these bulletins and reviews are thus forwarded back to the manufacturer, for appropriate response.

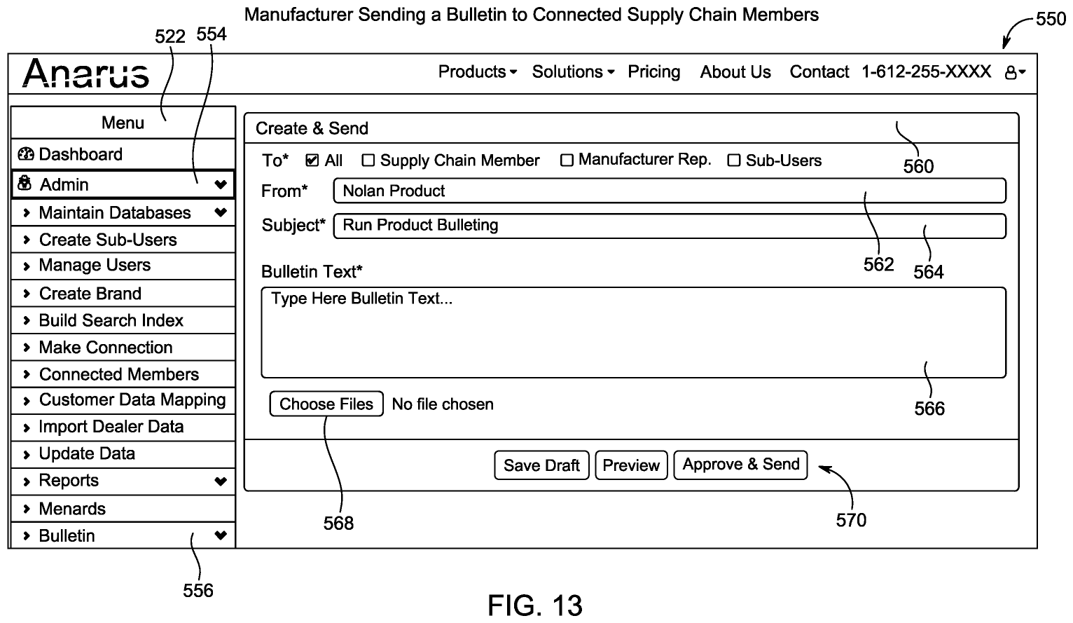

As presented in FIG. 13, manufactures can send bulletins or other product specific information to their connected supply chain members. In this particular situation, user interface 550 is presented as a result of selecting “bulletin” key 556 within menu 522. As shown, this is a subgroup of the admin 554 menu selection, which opens up many options for the manufacturer. In bulletin creation screen 560, a manufacturer is provided with the tools necessary to create and send a bulletin to particular supply chain members. Here, a from window 562 is provided along with a subject line window 564, allowing a manufacturer to input the necessary information. In a similar matter, a bulletin text window 566 allows for the creation of an appropriate message by the manufacturer, which will be transmitted as part of this bulletin, further, files can be chosen using selection button 568, which can be attached to this bulletin, such as spec sheets, drawings, product testimonials etc. Once the message is created, user is provided with various action buttons 570 such as save draft bulletin, preview bulletin, or approve and send. As will be expected, by hitting approve and send the system will generate appropriate bulletin and transmit it to the listed supply chain members. Naturally, similar tools and other options can be provided to a manufacturer, which will follow a well-accepted standards and tools which are well recognized by those skilled in the art.

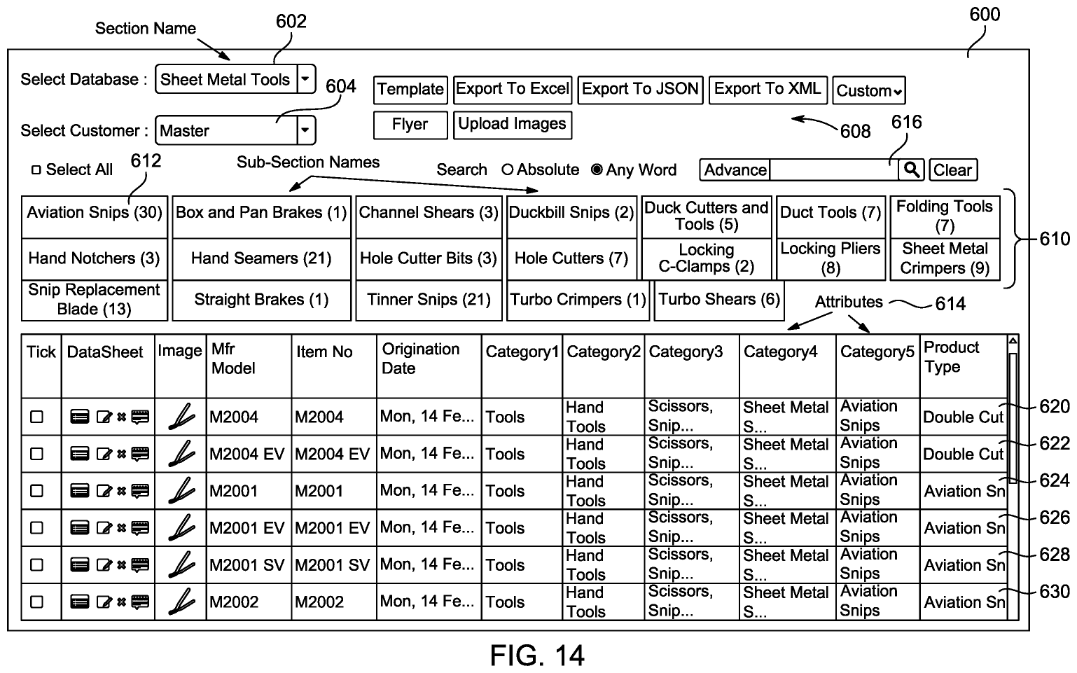

Based upon the discussion above, the product data exchange system 10 makes use of the data structures and related logic to provide a very effective tool for the controlled sharing of product data. To further outline the efficiency and effectiveness of the system 10, FIG. 14 illustrates one example of the way information is provided to and accessed by a supply chain member. Once a supply chain member's login is authenticated, information is displayed (or returned for display, if API connected) similar to that presented in product display 600. As shown, this provides a listing of large amounts of information, including information from connected manufacturers, by reading which manufacturers IDs are present in the member's account in the users database.

As illustrated in FIG. 14, a product display interface 600 provides several tools for a supply chain member to access and retrieve information related to products supplied by manufacturers who have allowed access to their information. Here, a section selection tool 602 is provided, where a user is provided with the ability to select a particular database. In this example, it is presumed that the user has selected a particular manufacture, and the more specific selection interface 600 provides ways for a supply chain member to focus on a particular product lines, categories, or other selections. Here, a customer selection box 604 is also provided which allows for the appropriate identification of the manufacturer involved. In this example, a number of subsection selections 610 are provided, which in this example the category “aviation snips” 612 has been selected. Further, a word search box 614 is provided to further focus a product search. Once appropriate selections have been made, an attributes 614 is presented, which includes several rows and columns listing specific products, and various attributes. Product rows 620-630 provide information regarding a specific product. As will be appreciated, the manufacturer will have control of this information and can select it in a manner most efficient for the supply chain member. From here, the supply chain member can select various products, and export various types of information in desired formats, using the format selection option 608 as presented in user interface 600.

The system will operate behind the user interface to have information presented as shown in FIG. 14. The selection of manufacturers could be achieved in many ways, including a simple display having a listing of manufacturers, or via a drop-down menu on a user interface. The supply chain member then has the ability to select a connected manufacturer, which will then cause the system to display (or return) a listing of the allowed (or authorized) databases associated with that manufacturer which will be shown in selection box 604. Again, this information is already in supply chain member's user account record 150, as generally illustrated in FIG. 4. Once supply chain member selects a database from a manufacturer, the system 10 will examine the manufacturer's account info in company database 200. More specifically the system will search for the container ID 204 for that manufacturer. Again, the supply chain member's user account 150 includes the allowed database name 252 along with allowed group and subgroup information. Further, within each manufacturer's containers is product information, with each product record will have a unique product ID along with a database name, group name(s) and subgroup name(s). When looking for specific product information, the database name, group name and subgroup name within the supply chain members user record is first pulled, and then a query is done in the manufacturer's container (identified by the container ID) based upon the database name, group names(s) and subgroup name(s). Using this, records in the identified container that this supply chain member is allowed to are identified and retrieved. Using these records, information can be displayed, returned or downloaded in a desired format (JSON, Excel, CSV etc.). Using selection options 608.

Various embodiments of the invention have been described above for purposes of illustrating the details thereof and to enable one of ordinary skill in the art to make and use the invention. The details and features of the disclosed embodiment[s] are not intended to be limiting, as many variations and modifications will be readily apparent to those of skill in the art. Accordingly, the scope of the present disclosure is intended to be interpreted broadly and to include all variations and modifications coming within the scope and spirit of the appended claims and their legal equivalents.

1. A cloud-based system for the controlled exchange of product between a plurality of manufacturers and a plurality of supply chain members, comprising:
a storage system configured to save a plurality of records within a plurality of containers, wherein the plurality of records comprises supply chain member user records, manufacturer user records, manufacturer company records and product records, and wherein each of the plurality of records are stored in a JSON text format, wherein each manufacturer record comprises unique information identifying each of the plurality of manufacturers, wherein each of the plurality of supply chain member records comprises unique information identifying each of the supply chain members and wherein each of the product records comprises a unique identifier associated with a product and a plurality of product attributes for the product; and
a processing system configured to generate a plurality of user interfaces in a manner which will allow manufacturers to control access to product records so that only connected supply chain members are allowed to see a predetermined set of product information for the manufacturer;
wherein each of the product records further has a plurality of product information, with the product information having the unique identifier associated with the product and a listing of the unique identifiers associated with one of the plurality of manufacturers, wherein the plurality of product records will further have a group identifier, the manufacturer record further comprising a share string containing the unique information identifying each of the users who will be allowed to access some segment of the manufacturer information and each supply chain member record will include a listing of allowed product records and/or product group information.

2. The cloud-based system of claim 1 wherein the unique information identifying each of the plurality of manufacturers comprises a unique manufacturer GNIN, the unique information identifying each of the supply chain members comprises a unique supply chain member GNIN and the unique identifier associated with a product comprises a unique product ID.

3. The cloud-based system of claim 2 wherein the user interface is provided via an API.

4. The cloud-based system of claim 2 wherein the product information includes specifications and links to documents.

5. The cloud-based system of claim 2 wherein each manufacturer is assigned a container for the storage of a plurality of databases.

6. A product data exchange system for providing product information affiliated with at least one manufacturer to a plurality of supply chain members, comprising:
A data storage system for storing a user database, a company database and a product database in at least one container;
wherein the user database is configured to store a manufacturer user record affiliated with the manufacturer having a unique manufacturer user GNIN and manufacturer information, and the user database is further configured to store a plurality of a supply chain member user records affiliated with the plurality of supply chain members with each of the plurality of supply chain member records having a unique supply chain member user GNIN and supply chain member information, and wherein the manufacturer user record further stores the unique supply chain member GNIN for those supply chain members that are allowed to access information for the manufacturer, and wherein the supply chain member user records for those supply chain members that are allowed to access information for the manufacturer will store the unique GNIN for the manufacturer and a plurality of access information;
wherein the company database stores a company record for the manufacturer which comprises the unique user GNIN for the company, a container ID, a database ID and a plurality of product IDs;
wherein the product database is identified by the database ID and is stored in a container identified by the container ID and contains a plurality of product records, wherein each product record is identified by a unique product ID which is one of the plurality of product IDs also stored in the company database and at least one group identifier; and
at least one processing system configured to interact with the data storage system to allow product information to be shared by the manufacturer in a controlled manner, wherein the processing system will allow the manufacturer to store the unique supply chain member user GNIN for only those supply chain members that are allowed to access information for the manufacturer, and wherein the supply chain member user records for those supply chain members that are allowed to access information for the manufacturer will include the a unique manufacturer user GNIN and related access information including the relevant database ID and at least one allowed group identifier; and
wherein, upon request by a supply chain member for desired product information related to a product affiliated with the manufacturer, the processing system will return the desired product information to the supply chain member only if the supply chain member's user GNIN is stored in the manufacturer's user record, and the a unique manufacturer user GNIN and the related group information for the desired product information is listed in the supply chain member user record.

7. The system of claim 6 wherein the manufacturer user record, the plurality of supply chain member user records, the company records and the product records are all stored in a JSON format.

8. The system of claim 7 wherein the user database, the product database and the company database are all stored in a cloud storage environment.
